(19) United States
(12) Patent Application Publication
(10) Pub. No.: US 2018/0168896 A1
(43) Pub. Date: Jun. 21, 2018

(54) A TRANSPORT AND COMPONENTS THEREFOR

(71) Applicant: ResQdevices Pty Ltd., South Wales (AU)

(72) Inventor: Roger Price, Homsby Heights (AU)

(73) Assignee: ResQdevices Pty Ltd., South Wales (AU)

(21) Appl. No.: 15/127,513

(22) PCT Filed: Mar. 20, 2015
(86) PCT No.: PCT/IB2015/052056

§ 371 Date: Sep. 20, 2016

(51) Int. Cl. A61G 1/017; A61G 1/02; A61G 1/044; A61G 5/00; B60B 25/02

(52) U.S. Cl. CPC A61G 1/017; A61G 1/0212; A61G 1/0287; A61G 5/1008; A61G 5/006; B60B 25/02; A61G 1/044

(57) ABSTRACT

A transport for material, item or a subject, is described, the transport including a support for the material, item or subject; one or more detachable ground engaging wheels, detachable from the support at a detachable mount; one or more lifts to facilitate lifting the support from ground level to a selected height, the lift being operatively connected to the support and the one or more detachable ground engaging wheels, when the wheels are attached to the support. A collapsible wheel is also described, having a plurality of arcuate segments, each one pivotally connected to adjacent ones at their ends; an adjustable-length flexible spoke connected to opposed or remote ends so that variation of the length of the spoke deploys or stows the collapsible wheel; a spoke length adjuster.

### FIELD OF THE INVENTION

The present invention relates generally to handling and transport of material and patients. In one particular application, the invention relates generally to prehospital handling of patients, in particular, transporting patients from a home, remote or trauma site to some more convenient treatment site with more treatment resources. However it is to be understood that aspects of the present invention may find application in handling and transport of many kinds of goods, so that aspects of the present invention may generally relate to handling of garden matter (wheelbarrows), stock in warehouses, personal effects such as when moving house, or play equipment such as skateboards, bicycles, and other transports for recreation.

### BACKGROUND TO THE INVENTION

The application of the present invention and the background being discussed hereinbelow relates to patient handling and in particular, manual patient handling. However, it is to be understood that some aspects of the present invention may find application in many areas such as for example handling of garden matter, stock in warehouses, personal effects such as televisions, couches, tables, chairs or in recreation equipment where a person may wish to be transported by a motor or freely down a hill such as in a billy cart or go kart.

Handling of patients (or subjects) can be difficult in the prehospital environment. Patients can be found in a variety of locations which can be difficult to access and provide treatment when a carer is at the location. Furthermore, the disposition of patients when found can lead to difficulties in transporting to a reasonable care location. That is to say the patient can be on a bed, on a floor, in a range of body positions. Taking the patient from any one of those positions and transferring to a patient transport can be difficult.

Difficulties arise because there can be narrow pathways between obstacles, stairs, staircases, short landings between staircases, turning circles of a tight radius, and other undulations. These all add to patient discomfort and ultimately making treatment more difficult.

Also, any one of these obstacles can make it difficult for a carer to lift and lower and twist while carrying or otherwise transporting the patient, increasing risk of injury to the carer. An injured carer can delay treatment of the patient and create another problem, requiring acute care for the carer, or worse, chronic care or ultimate burnout of the carer, inhibiting that carer from being able to care for patients.

Transporting known patient transports requires a large space in an ambulance or other prehospital treatment vehicle, and furthermore, known transports are heavy and expensive, or if not heavy and expensive, can be in the form of sheets or boards, which, it can be seen, are not useful for reasons above.

The present invention seeks to ameliorate one or more of the abovementioned disadvantages, and/or at least provide a new patient transport, and/or a useful patient transport alternative.

### SUMMARY OF THE INVENTION

Broadly, in one form the present invention provides a transport that includes a convertible material or subject support for transporting a subject or material around tight corners and/or other difficult sites. Broadly, in another form the present invention provides a portable patient support for portable transport of the support to a trauma site. Broadly, in yet another form, the present invention provides a patient transport which can be transported in stowed form until next to a patient to effect convenient access to a pickup site, then provide fast and convenient assembly, and then provide fast and convenient patient transport from a difficult trauma site through difficult accessways. Broadly, still another aspect of the present invention provides a portable patient transport which is convenient to load a fallen or other patient on, and convenient to transport the patient from difficult sites, and facilitate loading into an ambulance. Broadly an aspect of the present invention provides a transport that can be stowed into a small space, deployed quickly and taken to a difficult site, or carried easily to that site and deployed there.

According to one aspect of the present invention there is provided a transport for material, item or a subject, the transport including:
a. a support for the material, item or subject;
b. one or more detachable ground engaging wheels, detachable from the support;
c. one or more lifts to facilitate lifting the support from ground level to a selected height, the lift being operatively connected to the support and the one or more detachable ground engaging wheels, when the wheels are attached to the support.

According to one aspect of the present invention there is provided a transport for a subject, the transport including:
a. a collapsible support for supporting the subject;
b. one or more detachable ground engaging wheels, detachable from the collapsible support.

According to one aspect of the present invention there is provided a ground engaging wheel for use on a transport for material, an item or a subject, the ground engaging wheel including:
a. a collapsible wheel;
b. one or more detachable connectors for connecting the wheel to a chassis or a body of a transport.

According to one aspect of the present invention there is provided a ground engaging wheel for use on a transport for material, an item or a subject, the ground engaging wheel including:
a. a hub;
b. one or more connectors for connecting the hub to a chassis or a body of a transport;
c. a ground engaging rim portion connected to the hub for rotation about the hub.

According to another aspect of the present invention there is provided a kit for portable transport for a subject, the kit for portable transport including:
a. a support for a subject;
b. one or more detachable ground engaging wheels;
c. a keeper for the support and detachable wheels to be kept adjacent to one another.

14. In one embodiment the support is a board so that a patient may lie supine thereon. In one embodiment the board can be assembled from two or more board elements. In one embodiment the board elements are elongate board elements extending from a first end of the board to the second end. In one embodiment the elongate board elements can be secured to one another by clamps. In one embodiment the clamps have a locking overcentre mechanism for greater securing when in a secured or closed position.

In one embodiment the support includes a support frame for providing a structure to the support. In one embodiment the support frame includes a plurality of sub frame assemblies for supporting various parts of a subject. In one embodiment one of the plurality of sub frame assemblies is a back support sub frame. In one embodiment one of the plurality of sub frame assemblies includes a leg support sub frame. In one embodiment the leg support sub frame includes an upper leg support sub frame and a lower leg support sub frame. A foot support sub frame may also be provided.

The support frame assemblies may include peripheral frame elements for mounting articulating elements and the ground engaging wheels. Board elements may be mounted between or on the peripheral frame elements.

In one embodiment the support frame is collapsible. Any suitable collapsing mechanism may be employed to collapse the support frame and make it smaller to facilitate negotiating tight corners and spaces. In one embodiment the collapsible support frame includes one or more telescoping elements so that the support frame can be reduced in length for convenient carrying to a site without a patient or for convenient transport of a patient from a site if, say, the patient is small or in a curled-up position. In one embodiment the collapsible support frame includes one or more articulating elements so that sub-frames of the support frame may articulate relative to one another. In one embodiment the articulating element is a hinge, which may be integral with the support frame or may be attached thereto.

In one embodiment there is a plurality of hinges for articulation. In one embodiment the plurality of hinges may be disposed at various spaces along the support frame so that the support frame may be folded to form a seat such that one sub frame is generally perpendicular to an adjacent sub frame, and/or that another sub frame is generally perpendicular to another adjacent sub frame. Thus, in one embodiment there may be leg sub frame(s) extending outward to support legs straight outwards while a back sub frame is generally vertical, or in another embodiment there may be a lower leg sub frame extending generally perpendicularly to an upper leg sub frame, so as to form a wheeled chair arrangement. In one embodiment the sub frames may articulate or extend independently or together, so that one leg may be extended and supported perpendicular to the back sub frame, while the other leg may be folded more naturally so that an upper leg portion is disposed perpendicular to the lower leg.

In one embodiment the board is collapsible. Any suitable collapsing mechanism may be employed to collapse the board and make it smaller to facilitate negotiating tight corners and spaces. In one embodiment the collapsible board includes one or more telescoping elements so that the board can be reduced in length for convenient carrying to a site without a patient or for convenient transport of a patient from a site if, say, the patient is small or in a curled-up position. In one embodiment the collapsible board includes one or more articulating elements so that one portion of the board may articulate relative to another portion of the board. In one embodiment the articulating element is a hinge, which may be integral with the board or may be attached to the board.

In one embodiment the plurality of hinges may be disposed at various spaces along the board so that the board may be folded to form a seat such that one board portion is generally perpendicular to an adjacent board portion, and/or that another board portion is generally perpendicular to another adjacent board portion. Thus, in one embodiment there may be leg board portion(s) extending outward to support legs straight outwards while a back support is generally vertical, or in another embodiment there may be a lower leg portion extending generally perpendicularly to an upper leg portion, so as to form a wheeled chair arrangement. In one embodiment the board portions may articulate or extend independently or together, so that one leg may be extended and supported perpendicular to the back support, while the other leg may be folded more naturally so that an upper leg portion is disposed perpendicular to the lower leg.

It can be seen that the lower leg sub frame hinge (adjacent the knee) may articulate independently of the back sub frame so as to reduce the length of the patient and facilitate navigation of tight corners without bending the patient at the hips, which may be uncomfortable for various patients depending on their condition.

In one embodiment the back support may be transported in the horizontal position and the legs transported generally vertically, or the lower leg being parallel with the back while the upper leg is supported vertically, the latter position such that the patient is disposed in the astronaut position.

In one embodiment the hinges and telescoping collapsing devices include one or more stopping positions. For example the hinges may be lockable in an infinite number of, or plurality of discrete angular positions, so that the patient may be supported in a suitable position to facilitate their comfort depending on their condition. This function is provided by a lock or a detent, the structure and operation of which will be explained herein below and shown in the drawings.

In one embodiment the collapsible board may be completely collapsed to a short stowed position, in which the board may be folded with sub frame or board elements atop one another and in a generally cube or box-shaped form. In another stowed position, the board is disposed in a flat elongate or stretcher position to reduce height, where the sub frame or board portions extend end to end. so as to be disposed, say, along a wall of an ambulance.

In one embodiment there may be a foot support provided on the support. In one embodiment the foot support folds outward from the sub frame or board at a foot end of the sub frame or board. In one embodiment there are two foot supports disposed side by side and they may be independently unfolded or locked together for unfolding. In one embodiment the foot support may be detachable.

In one embodiment retainers may be provided for retaining material, an item, or a subject or patient. In one embodiment the retainers are side walls attachable to and detachable from the support. In one embodiment the side walls extend along a portion of the board so as to provide support and retention from falling off the board, but also access to the patient, and cooling for the patient. In one embodiment the side walls are about 300 mm long.

In one embodiment the side walls slide into the side of the board to facilitate their assembly to the board. Having said that, any suitable fastening mechanism, even ones other than sliding ones, such as plug-in ones, catches, and the like, may be employed to fasten the walls to the board. In one embodiment the or each wall includes a rib at a connecting end which can be received in a cooperating bight, like a semi-closed groove partially open at a side edge and extending along the side edge of the board. Preferably the bight is open at one end and closed at another so that the wall has a natural stop once it has been slid along the board and into a selected position.

In one embodiment the side walls include secondary retainers for retaining patients onto the board. In one embodiment the secondary retainers are return edges on the side walls to inhibit patients sitting up or falling out, or any suitable secondary retention. In one embodiment the secondary retainer is a strap, closed by a buckle or a suitable fastener including a hook and loop fastener. In one embodiment the straps fasten to distal ends of the side walls, the distal ends being the wall ends remote from the ends which attach to the board. Strap apertures are provided in one embodiment in the distal ends.

In one embodiment the secondary retainers are directly mounted into grooves or threaded through bars on the side edge of the board, the grooves being provided so that those retainers and other items can be attached at a selected convenient location along the board.

In one embodiment the support frame or board is ground engaging and suitable to be disposed on the ground. In one embodiment there are provided secondary ground-engaging wheels to facilitate sliding the support frame or board under a fallen patient. The wheels may be able to roll the support frame laterally or longitudinally.

The ground engaging wheels may be in any suitable form to facilitate transport of material or patients on the support. The ground engaging wheels may be spoked like a bicycle wheel. There may be tyres filled with rubber or air disposed on the rim for increased patient comfort and absorption of bumps.

In one embodiment the ground engaging wheels include a hub and a ground engaging rim portion connected to the hub for rotation about the hub. In one embodiment the wheel is in an axle-less form and in that form the hub is disposed a selected radial distance from a centre of rotation of the wheel. In one embodiment the hub is an annulus for supporting the ground engaging rim portion. In one embodiment the hub includes a race for bearings for providing freedom of rotation for the ground engaging rim portion. In one embodiment the hub includes a mounting for the ground engaging portion.

In one embodiment the annulus is detachably mounted to the board, and in any suitable manner for detachably holding the annulus fixed against a side portion of the support or board, such as for example, with a bolt and nut. In one embodiment the annulus includes one or more stubs extending from a wall of the annulus which to detachably connect is received in a cooperating receiver on the board or support side wall.

In one embodiment the wheel is collapsible. In one embodiment the collapsible wheel includes an annulus having a plurality of arcuate elements connected to one another. In one embodiment there are provided two, three, four, five, six, seven, eight, nine, ten, eleven, twelve, or some suitable number of arcuate elements. In one embodiment there are four arcuate elements. In one embodiment the arcuate elements are pivotally connected to one another a joints provided at their ends. In one embodiment the arcuate elements are rigid. In one embodiment the arcuate elements are rigid but somewhat flexible. In one embodiment the arcuate elements are constructed from a plastic, or carbon fibre, or aluminium, or steel, or like material. In one embodiment the wheel is about 700 mm in diameter but could be bigger or smaller, to facilitate traversing stairs and other bumps and general contoured terrain.

In one embodiment an adjustable spoke is provided between opposed joints to control the relative disposition of opposed joints. In one embodiment a plurality of adjustable spokes are provided. In one embodiment the adjustable spokes are flexible but they may be a rigid bar. In one embodiment each one of the adjustable spokes is a cable and there may be one or more cables. In one embodiment there is provided a winder or windlass or drawing device to shorten the adjustable spoke to move it from a stowed (or flattened) position to a deployed (rolling) position. The winder may be releasable or on a ratchet so as to allow rapid stowing from a deployed position under the force of gravity.

In one embodiment each joint of each arcuate element includes a stop to inhibit over-winding or over-deployment into an off-round position. In one embodiment the stop is a lap joint, which includes a tongue at one end of an arcuate element and a tongue receiver at a cooperating position on an adjacent arcuate element. In one embodiment the tongue is on an outside of outer (or end) opposed joints and on an inside of inner (or side) opposed joints to facilitate support of round form when deployed and so as not to inhibit stowing flat.

The lift may be in any suitable form for facilitating elevating the support from a ground position to a transport position. In one embodiment the lift is powered. In one embodiment the power is provided by electricity, stored or otherwise connectable to the transport, or by compressed air, again connectable or stored on board, or by hydraulics, stored on board or connectable to the transport. In one embodiment the lift is mechanical and driven by shafts of external powered motors.

In one embodiment the lift is operatively connected to the collapsible wheel and when the wheel is connected to the support, the lift draws the cable ends together and the support is then elevated from a ground position to an ambulance-loading position.

In one embodiment the lift is integrated into the detachable mounting for the annulus. In one embodiment one or more of the stubs extending from the wall of the annulus is mounted so as to move around the annulus so that the board can be moved relative to the circumference of the annulus. That is, when the stubs are disposed adjacent one another on the board and wheel, the board is disposed so as to be generally tangential to the rim of the wheel. Because of the rotatable nature of the ground engaging rim portion, when the stubs are so arranged the board resides adjacent or on the ground.

In one embodiment to lift the board the stubs may be driven around the annulus. To facilitate that kind of lift, the stubs are mounted in the side of the board or support in tracks. Driving the stubs apart along the tracks in this embodiment results in elevating or lifting the board relative to the ground. Driving the stubs apart may be done in any suitable manner—either mechanically, by mounting the one or more movable stubs in the track on a threaded bar mounted in the track and winding the threaded bar, or by mounting the movable stubs on pivoting, threaded carriages, and winding the carriages, (as long as the carriages have a two-part mount, one part of which can rotate relative to the stub) by providing a battery powered drill to wind the threaded bar, or by an air powered drill to wind the bar, or some other powered motor having an output shaft. In one embodiment the separation of the two stubs could be achieved by providing a ratchet and pawl, the rack of the ratchet being disposed in the tracks or on a bar mounted therein, and mounting one stub on a pawl and driving that one stub directly away from the other, or mounting both on a pawl and driving them both apart from one another at once. An onboard battery could drive the two stubs apart by rotating the mounts or a bar, or by directly pushing the stubs along the track. The stub ends could be mounted in a hydraulic tube, or a similar and suitable arrangement.

In another arrangement there is provided a wheel support frame, for each wheel, which is mounted in grooves on peripheral frame elements of a support frame, or in the side of a board, to facilitate lifting and selection of any suitable height of lift, particularly from ground level. In one embodiment the wheel support frame includes a plurality of wheel support arms pivotally connected by a pivot at a pivoting joint so as to facilitate lifting. In this embodiment there are provided two wheel support arms pivotally connected at a wheel hub at a first end, and pivotally connected to peripheral frame elements at their second ends.

In one embodiment a drive is provided at the pivoting joint between the wheel support arms at their first ends so that the joint may be driven to change the angle between the wheel support arms to change the height of the support. In one embodiment the drive is a gear train so as to provide a mechanical advantage when driving the joint. There is provided in one embodiment a worm gear in the joint and one or more bevel gears operatively connected to the worm gear. A drive shaft is provided to drive the one or more bevel gears. There is provided one drive shaft for each bevel gear or a link between the two sides of the support to drive two wheel support frames at once from one drive input position. The drive shaft or each drive shaft may be flexible or jointed with universal joints so as to extend along a contour of peripheral frame elements.

In one embodiment a lock is provided to lock the wheel support frames in the grooves at the side of the board.

In one embodiment a lift drive is provided to lift the wheel support frames. In one embodiment the lift drive independently operates each wheel support frame, while in another embodiment a link is provided to lift both wheel support frames at the same time.

In one embodiment the pivoting joint has more than 180 degrees of rotation so that the wheel support frame can invert such that the support arms can form a V or an A shape. The wheel support arms are detachably mounted at their second ends to the support frame and thus when the support arms are in the form of a V the wheel is engaging the ground, and the support frame is elevated. When the wheel support arms are in an A-shape, the wheel is held high off the ground at the vertex of the A and therefore it can be seen that the support frame is disposed in a ground engaging position, or close thereto, and the patient can be loaded.

In one embodiment the lift drive includes a drive train and a drive shaft. In one embodiment the drive shaft is flexible or articulated such that it follows the contours of a frame element of the board.

In one embodiment the wheel is collapsible. In one embodiment the collapsible wheel includes a plurality of wheel segments connected to one another. In one embodiment the wheel segments are detachably connected to one another. In one embodiment the wheel is articulated and the segments are hinged to one another. In one embodiment the wheel segments are locked together with a clamping lock.

In one embodiment the wheel segments are annular so that the hub is in a form which is radially spaced from the centre of rotation. In one embodiment the annular wheel segments are arcs extending around an angle of 180 degrees so that the wheels fold in half or are detachable into halves.

In one embodiment the wheels are hinged so as to fold against one another to reduce their stowed diameter. That is, they hinge outside the plane of rotation and then fold flat, annulus against annulus.

In one embodiment the wheels include a race in an outer edge so as to receive and rotatably mount a ground engaging rim element, or tyre. In one embodiment the race includes bearings so that the rim runs freely around the outer edge of the hub.

In one embodiment the retainer for the transport kit includes a strap. In one embodiment the retainer includes a case. In one embodiment the case includes a strap for carrying. In one embodiment the case is elongate to receive the board elements disposed in their elongate positions, the folded or detached wheel portions, and the retaining side wall portions to facilitate stowing the transport.

In one embodiment the support includes handles for manoeuvring the transport and lowering it down stairs and the like. In one embodiment the handles extend from one end of the support frame or board. In one embodiment the handles include grip regions in one form being short bars extending perpendicular to the support frame or board sides for ergonomic grip.

The handles may be mounted on a top of the support frame or underneath, so as to obtain the most convenient grip for taking the transport down stairs or up stairs. This is facilitated by through holes in peripheral frame elements or through holes in the board, at a head end of the support frame.

In one embodiment the grip regions include brake actuating handles for convenient use of brakes.

In one embodiment brakes are provided in one form being fail safe, in that a braking element is held away from the rim, and mounted on the hub annulus, when the brake actuating handles are held in a release position. When the brake handles are released, the brake element is moved by a biasing element onto the rim and relative movement between hub and rim is inhibited by the brake element. In one embodiment the brakes are disc brakes disposed adjacent the pivot of the wheel support frame elements and operated by cables and cable actuators such as those found on a bicycle.

In one embodiment the stubs are disposed on one board element, so that the board elements can hinge and fold without having to move the stubs relative to one another. In one embodiment the stub tracks are disposed on different board elements. In one embodiment there is an interlock between the hinge and the mounts for the stubs, so that when the hinges for the boards move the board to a folded position, the stubs move relative to one another, allowing the board elements to hinge relative to one another and the board collapse.

In accordance with a further aspect of the present invention there is provided a collapsible ground engaging wheel for facilitating transport of a subject, the collapsible ground engaging wheel including:
a. a plurality of arcuate segments, each one pivotally connected to adjacent ones at their ends;
b. an adjustable-length spoke connected to opposed or remote ends so that variation of the length of the spoke deploys or stows the collapsible wheel;
c. a spoke length adjuster.

In one embodiment the spoke is a flexible element. In one embodiment the flexible element is a cable and the spoke length adjuster is a winder or windlass.

### BRIEF DESCRIPTION OF THE DRAWINGS

In order to enable a clearer understanding of the present invention, preferred embodiments will hereinafter be described with reference to the attached drawings, in which:

FIG. 1 is an isometric view of one embodiment of the present invention, shown deployed, flat and in a lowered position and a lifted position;

FIG. 2 is an isometric view of the transport of FIG. 1, shown deployed as a chair;

FIG. 3 is an isometric view of the transport of FIG. 1, shown deployed, raised, and supporting feet in a second chair position;

FIG. 4 is an isometric view of the transport of FIG. 1 without side walls, instead having straps;

FIG. 5 is an isometric view of the transport of FIG. 1 shown during assembly of the side walls to the board;

FIG. 6 shows the clamp to clamp two elongate parts of a board together;

FIG. 7 shows the clamp open, the board hinged at one end to scoop a patient onto the board;

FIG. 8 shows the board open in a scissor position to scoop the patient onto the board;

FIG. 9 shows the patient being rolled on the board assisted by the side walls;

FIG. 10 shows details of the wheels, being a separate aspect of the present invention;

FIG. 11 shows details of wheels, being a separate aspect of the present invention;

FIG. 12 shows details of the wheels of FIGS. 10 and 11;

FIG. 13 is a detail of the handles of the transport of FIG. 1;

FIG. 14 shows the transport being taken down stairs;

FIG. 15 shows the transport in kit form;

FIG. 16 is a side perspective view of a prototype in accordance with an embodiment of the present invention having some elements not shown for clarity and the prototype deployed having the support in a stretcher form, one wheel support in a lifted position, the other wheel support in a lowered position;

FIG. 17 is a side perspective view of the prototype of FIG. 16 showing one wheel assembly in an elevated position which would result in the support being in a ground engaging position;

FIG. 18 is a detail view of a side groove disposed in a back support sub frame for receiving a wheel support frame element pivot in the prototype of FIG. 16;

FIG. 19 is a side elevation view of the prototype of FIG. 16 the support frame being in a chair position, having back sub frame and leg sub frame deployed and folded about its sub frame hinges;

FIG. 20 is a plan perspective view of the prototype of FIG. 16 showing the flexible drive shaft to drive bevel gears on a wheel support frame to lift or lower the support;

FIG. 21 is a rear perspective view of the prototype of FIG. 16;

FIG. 22 is a detail view of a driven joint on wheel support frame showing bevel gears driving a worm gear inside the wheel support frame;

FIG. 23 is a plan perspective view of the prototype having the support in a stretcher position and the wheels in a lowered position so that the stretcher is in an elevated position so as to facilitate loading into an ambulance;

FIG. 24 is a plan perspective view of the prototype of FIG. 16 showing the support in a stretcher and elevated position;

FIG. 25 is a plan perspective view of the prototype of FIG. 16 in a kit form, disassembled for easy loading of a fallen patient;

FIG. 26 is a plan perspective view of the prototype of FIG. 16, in an assembled form and disposed to load a patient into an ambulance;

FIG. 27 is a side elevation view of a collapsible wheel which can be utilised in either one of the embodiments shown in FIGS. 1 to 15 or in the prototype shown in FIGS. 16 to 26;

FIG. 28 is a side elevation view of the collapsible wheel of FIG. 27 without an adjustable spoke;

FIG. 29 is a detail view of the collapsible wheel shown in FIG. 28;

FIG. 30 is a detail view of an end of an arcuate wheel portion for use in the collapsible wheel of FIGS. 27; and

FIG. 31 is a detail view of a cooperating end of the arcuate portion of FIG. 30.

### DETAILED DESCRIPTION OF PREFERRED EMBODIMENTS

Referring to the Figures there is shown a transport for material or a subject, the transport indicated generally at 10 and including a support 12 for the material, item or subject; one or more detachable ground engaging wheels 14, detachably mounted to the support 12 at a detachable mount; and one or more lifts 16 to facilitate lifting the support 12 to a selected height, the one or more lifts 16 being operatively connected to the support 12 and the one or more detachable ground engaging wheels 14.

The support 12 is in the form of a board 13 so that a patient 5 may lie supine thereon. The board 13 is assembled from two or more board elements 15, 17. The board elements 15,17 are elongate board elements extending from a first end of the board to the second end. The elongate board elements can be secured to one another by clamps 21, 22. The clamps have a locking overcentre mechanism for greater securing when in a secured or closed position.

The board 13 is collapsible. Any suitable collapsing mechanism may be employed to collapse the board and make it smaller to facilitate negotiating tight corners and spaces. In one embodiment the collapsible board includes one or more telescoping elements so that the board can be reduced in length for convenient carrying to a site without a patient or for convenient transport of a patient from a site if, say, the patient is small or in a curled-up position. In the embodiment shown the collapsible board includes one or more articulating elements: head 30, upper leg 31, lower legs 32 so that, say the head portion 30 of the board may articulate relative to the upper leg portion 31 of the board 13. In the embodiment shown the articulating element is a hinge 33, 34, which may be integral with the board so as to be in the form of a living hinge (not shown) or it may be attached to the board as shown in 33, 34.

In the embodiment shown there are two pairs of hinges. The hinges 33, 34 are disposed at essentially, thirds along the board so that the board 13 may be folded to form a seat such that one board portion, say, head 30, is generally perpendicular to an adjacent board portion, say, upper leg 31, and/or that another board, say lower leg 32 portion is generally perpendicular to another adjacent board portion, being upper leg 31. Thus, in the embodiment shown there are leg board portion(s) 31, 32, extending outward to support patient legs extending straight outwards while a back support is generally vertical, or in another embodiment there may be a lower leg portion 32 extending generally perpendicularly to an upper leg portion 31, so as to form a wheeled chair arrangement. In one embodiment the board portions 30, 31, 32 may articulate or extend independently or together, so that one leg may be extended and supported perpendicular to the back support, while the other leg may be folded more naturally so that an upper leg portion 31 is disposed perpendicular to the lower leg portion 32.

In the embodiment shown the lower leg portions 32 may be folded independently of the back so as to reduce the length of the patient and facilitate navigation of tight corners without bending the patient at the hips, which may be uncomfortable for various patients depending on their condition.

In the embodiment shown the back portion 30 may be transported in the horizontal position and the legs transported generally vertically, or the lower leg being parallel with the back while the upper leg is supported vertically, the latter position such that the patient is disposed in the astronaut position.

The hinges 33, 34 and telescoping collapsing devices (not shown) include one or more stopping positions. For example the hinges 33, 34 may be lockable in an infinite number of, or plurality of discrete angular positions, so that the patient may be supported in a suitable position to facilitate their comfort depending on their condition.

In one embodiment (not shown) the collapsible board 13 may be collapsed to a stowed position, in which the board may be folded with board elements atop one another. In another stowed position (shown in the Figures), the board is disposed in an elongate position to reduce height, where the board portions extend end to end, to follow the natural contour of an ambulance when disposed front to back, and to occupy a space presently occupied by a known patient support, a board.

In the embodiment shown there is a foot support 35 provided on the support 12. The foot support 35 folds outward from the board 13 at a foot end of the board. In the embodiment shown each board has a foot support 35 such that there are two foot supports and they may be independently unfolded or locked together for unfolding in unison. In one embodiment the foot support may be detachable (not shown).

In them embodiment retainers 40 are provided for retaining material, an item, or a subject or patient. In the embodiment shown the retainers 40 are side walls 41, 42, 43, 44 attachable to and detachable from the support 12. In the embodiment shown the side walls 41, 42, 43, 44 extend along a side portion of the board 13 so as to provide support and retention from falling off the board 13, but also access to the patient, and cooling for the patient. In one embodiment the side walls 41, 42, 43, 44 are about 300 mm long.

In the embodiment shown the side walls 41, 42, 43, 44 slide into the side of the board 13 to facilitate their assembly to the board. Having said that, any suitable fastening mechanism, even ones other than sliding ones, such as plug-in ones, catches, and the like, may be employed to fasten the walls to the board. In the embodiment shown the or each side wall includes a rib 45 at a connecting end which can be received in a cooperating bight 46, like a semi-closed groove partially open at a side edge of the board and extending along the side edge of the board 13. The bight 46 is open at one end 47 and closed at another 48 so that the wall has a natural stop once it has been slid along the board and into a selected position.

In the embodiment shown the side walls 41, 42, 43, 44 include secondary retainers 51, 52, 53, 54 for retaining patients onto the board 13. In one embodiment (not shown) the secondary retainers are return edges on the side walls to inhibit patients sitting up or falling out, or any suitable secondary retention. In the embodiment shown the secondary retainer 51, 52, 53, 54 is a strap, closed by a buckle 55 or a suitable fastener including a hook and loop fastener 56. In the embodiment shown the straps fasten to distal ends of the side walls 41, 42, 43, 44, the distal ends being the wall ends remote from the ends which attach to the board. Strap apertures 49 are provided in one embodiment in the distal ends.

In one embodiment shown, the secondary retainers are directly mounted into grooves 59 or threaded through bars on the side edge of the board.

The ground engaging wheels 14 may be any suitable form to facilitate transport of material or patients on the support 12. In the embodiment shown the ground engaging wheels 14 include a hub 60 and a ground engaging rim portion 62 connected to the hub 60 for rotation about the hub 60. In the embodiment the hub 60 is disposed a selected radial distance from a centre of rotation 61 of the wheel. In the embodiment shown the hub 60 is an annulus 63 for supporting the ground engaging rim portion 62. In the embodiment shown the hub 60 includes a race 64 for bearings 65 for providing freedom of rotation for the ground engaging rim portion 62. In the embodiment shown the hub 60 includes a mounting for the ground engaging rim portion.

In the embodiment shown the annulus 63 is detachably mounted to the board 13, and in any suitable manner for detachably holding the annulus 63 fixed against a side portion of the board 13, such as for example, with a bolt and nut. In the embodiment shown the annulus 63 includes one or more stubs 67 extending from a wall of the annulus which to detachably connect is received in a cooperating receiver track 66 on the board 13 side wall.

The lift 16 may be in any suitable form for facilitating elevating the support from a ground position to a transport position. In one embodiment the lift is powered. In one embodiment the power is provided by electricity, stored or otherwise connectable, or by compressed air, again connectable or stored on board, or by hydraulics, stored on board or connectable. In one embodiment the lifting is wholly manual.

In the embodiment shown the lift 16 is integrated into the detachable mounting for the annulus 63. In the embodiment shown there are two stubs 67 attaching the annulus 63 to the side wall of the board 13. One or more of the stubs 67 extending from the wall of the annulus 63 is mounted so as to be free to move around the annulus 63 so that the sides of the board 13 can be moved relative to the circumference of the annulus 13. That is, when the stubs 67 are disposed adjacent one another, the board 13 is disposed so as to be generally tangential to the rim 62. Because of the rotatable nature of the ground engaging rim portion 62, the board resides adjacent or on the ground.

In the embodiment shown one or more of the stubs 67 may be driven around the annulus by mounting the stubs 67 in the side of the board 13 in cooperating tracks 75. Driving the stubs apart along the tracks 75 in this embodiment results in elevating or lifting the board 13 relative to the ground. Driving the stubs 67 apart may be done in any suitable manner—either manually, by mounting the one or more movable stubs 67 in the track 75 on a threaded bar mounted in the track and winding the threaded bar, or by mounting the movable stubs 67 on pivoting, threaded carriages, and winding the carriages (as long as the carriages have a two-part mount, one part of which can rotate relative to the stub) providing a battery drill to wind the threaded bar, or by a pneumatic drill to wind the bar. In one embodiment the separation of the two stubs 67 could be achieved by providing a ratchet in the track and driving one stub 67 directly away from the other along the track 75, or both at once. An onboard battery could drive the two stubs 67 apart by rotating the mounts or the bar, or by directly pushing the stubs 67 along the track. The stub ends could be mounted in a hydraulic tube, or a similar and suitable arrangement.

In the embodiment shown the wheel 14 is collapsible. In the embodiment shown the collapsible wheel 14 includes a plurality of wheel segments 80, 81 connected to one another. In one embodiment the wheel segments are detachably connected to one another. In the embodiment shown the wheel 14 is articulated and the segments are hinged by hinge 82, 83 to one another. In the embodiment shown the wheel segments can adopt a stowed position in which the wheel segments hinge so as to fold flat against one another to reduce their stowed diameter. That is, they hinge outside the plane of rotation and then fold flat, annulus against annulus. The wheels also adopt a deployed position wherein the wheel forms a full circle and in the deployed position are locked together with a clamping lock 84.

The wheel segments 80, 81 are annular so that the hub 60 is in a form which is radially spaced from the centre of rotation. In the embodiment shown the annular wheel segments are arcs extending around an angle of 180 degrees so that the wheels fold in half or are detachable into halves.

In one embodiment the retainer 90 for the transport kit includes a strap. In the embodiment shown the retainer 90 includes a case 91. In the embodiment shown the case 91 includes a strap 92 for carrying. In the embodiment shown the case 91 is elongate to receive the board elements disposed in their elongate positions, the folded or detached wheel portions atop those, and the retaining side wall portions to facilitate stowing the transport atop the board elements at the other end of the board 13.

In the embodiment shown the board 13 includes handles 95 for manoeuvring the transport 10 and lowering it down stairs and the like. In the embodiment shown the handles 95 extend from one end of the board 13. In the embodiment shown the handles 95 include grip regions 96 in one form being short bars extending perpendicular to the board sides for ergonomic grip.

In the embodiment shown the grip regions 96 include brake actuating handles 97 for convenient use of brakes (not shown).

In one embodiment brakes are provided in one form being fail safe, in that a braking element is held away from the rim, and mounted on the hub annulus, when the brake actuating handles are held in a release position. When the brake handles are released, the brake element is moved by a biasing element onto the rim and relative movement between hub and rim is inhibited by the brake element.

In one embodiment the stubs 67 are disposed on one board element, so that the board elements can hinge and fold without having to move the stubs relative to one another. In one embodiment the stub tracks are disposed on different board elements. In one embodiment there is an interlock between the hinge and the mounts for the stubs, so that when the hinges for the boards move the board to a folded position, the stubs move relative to one another, allowing the board elements to hinge relative to one another and the board collapse.

Another similar embodiment of the present invention will be discussed hereinbelow, wherein like numerals will denote like parts. Some features will be able to be utilised across both embodiments, such as the different embodiments of collapsible wheel can be transferred across embodiments.

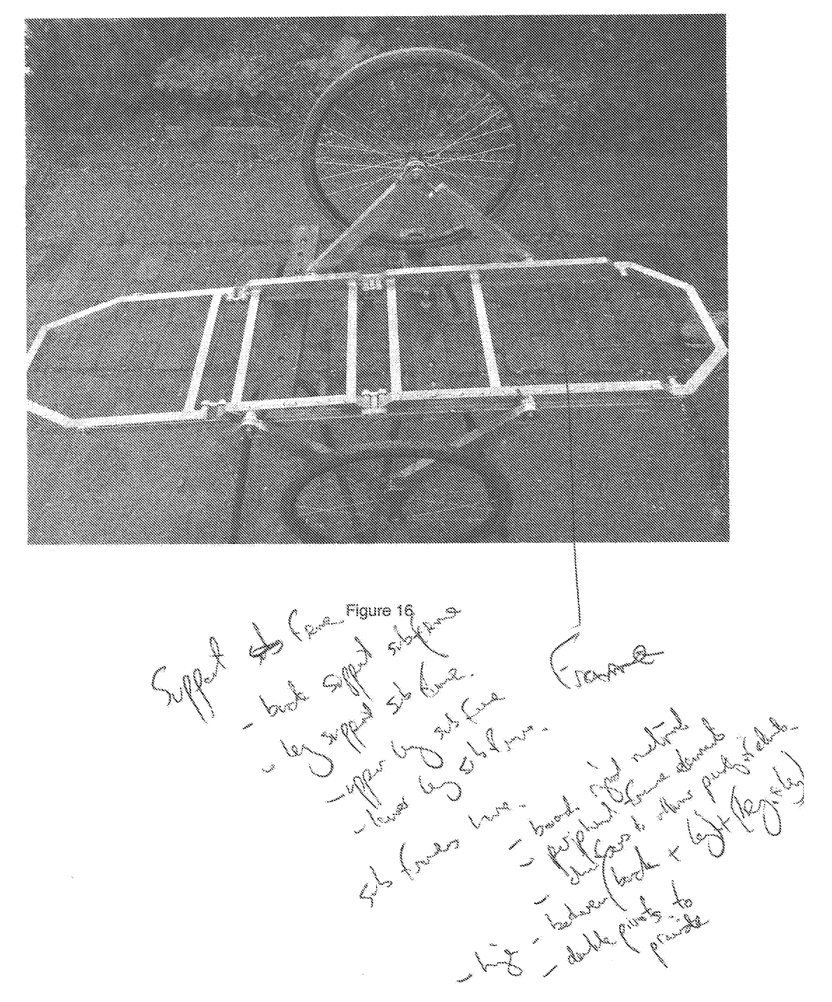

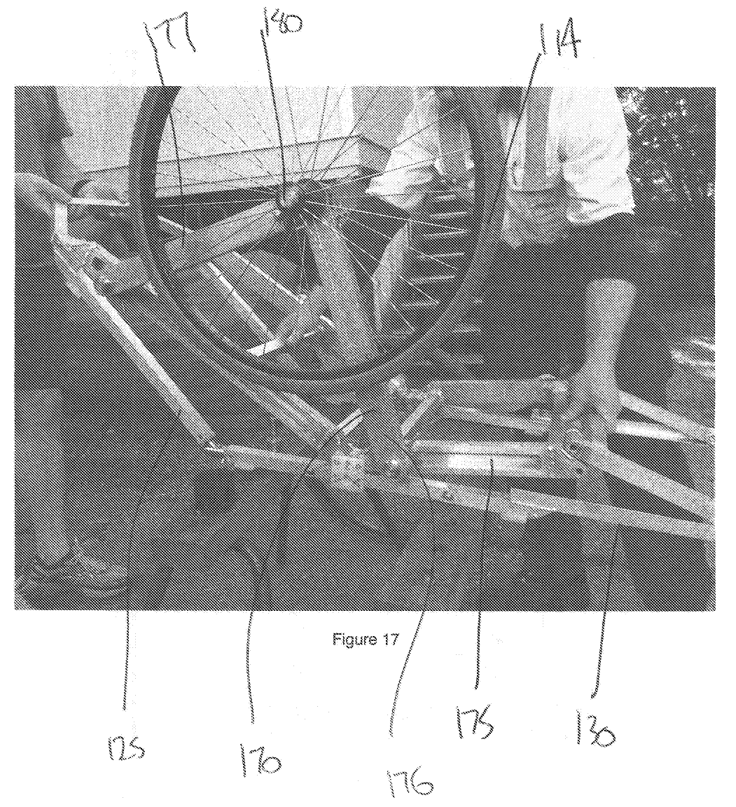

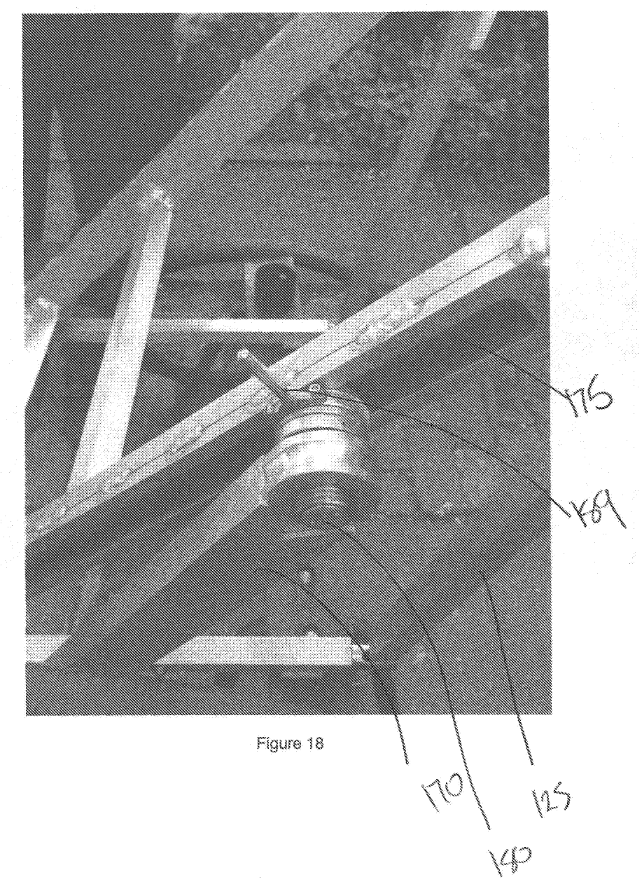

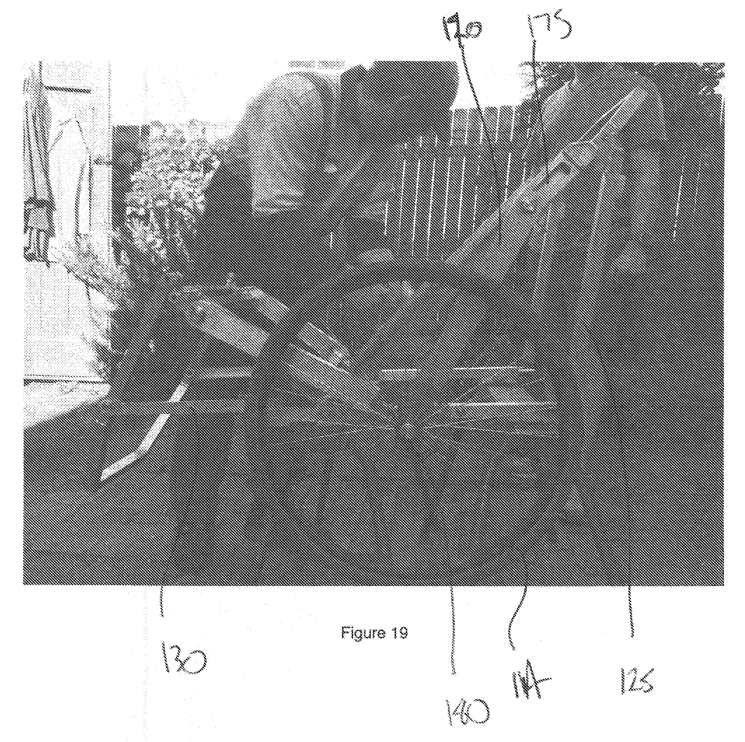

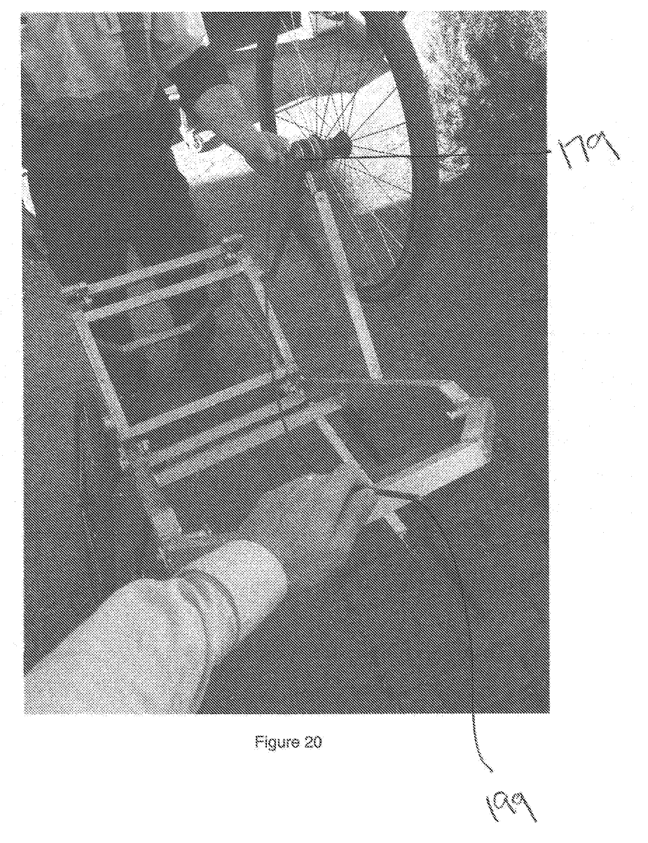

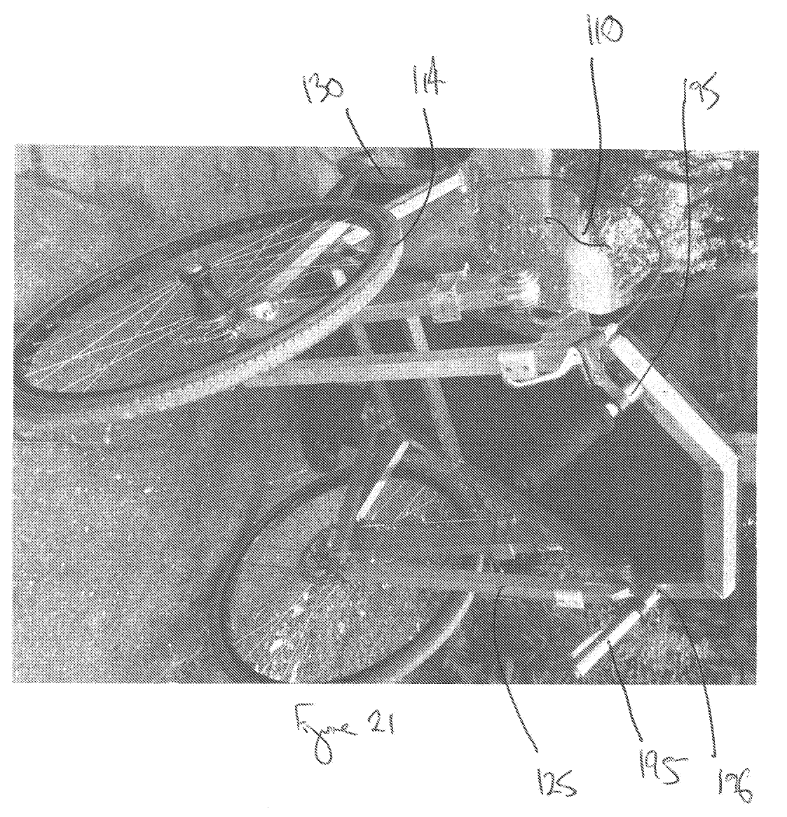

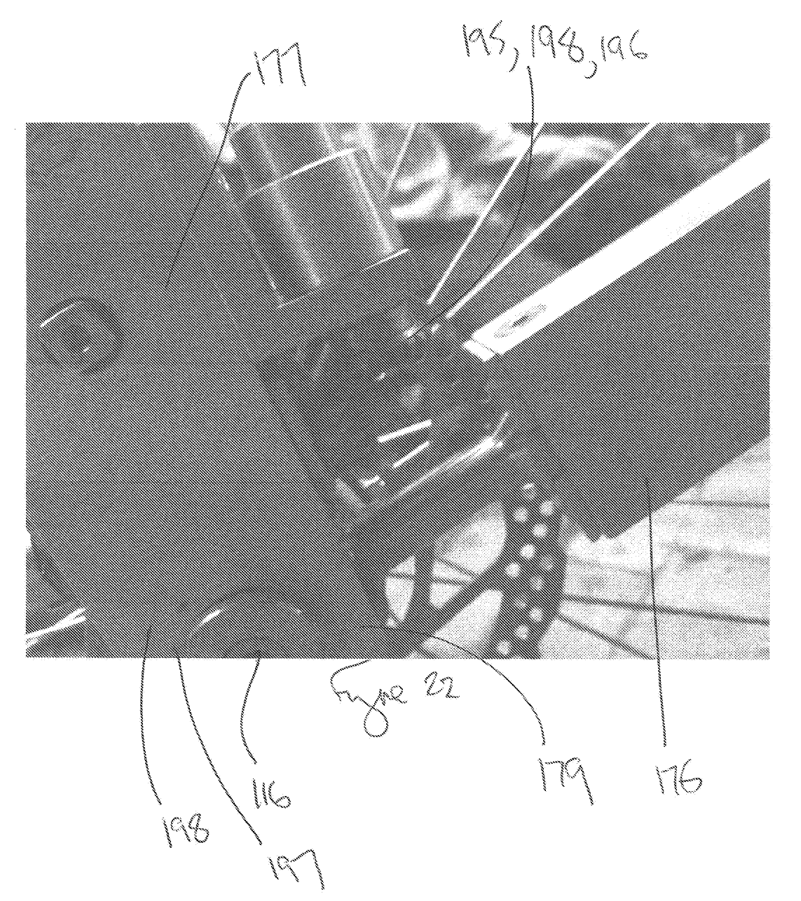

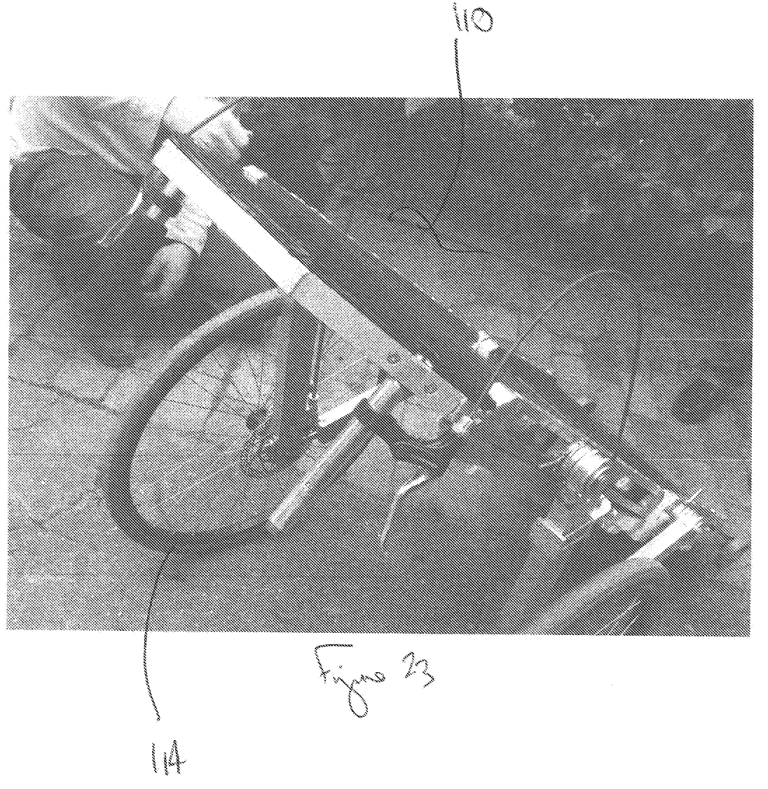

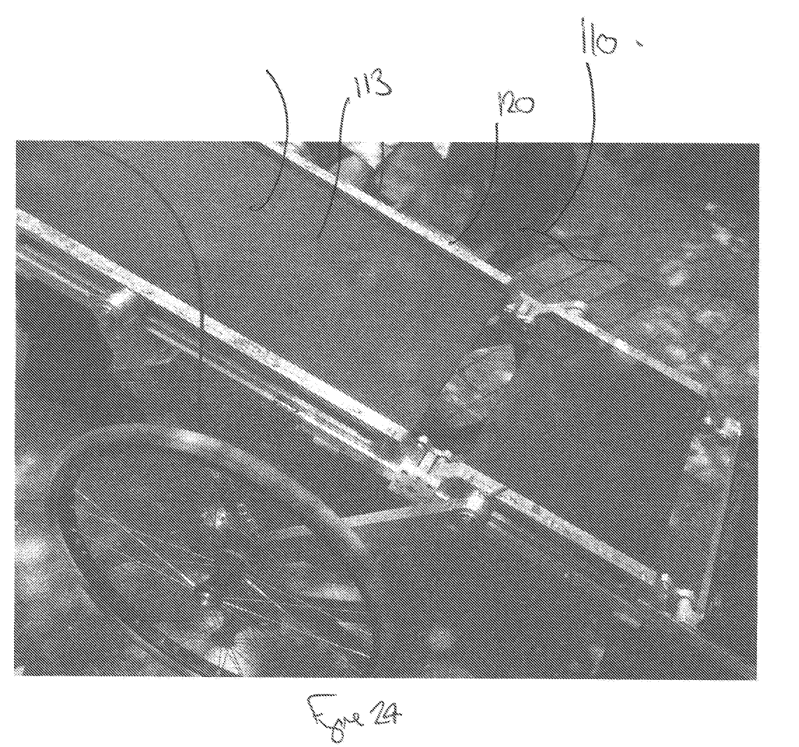

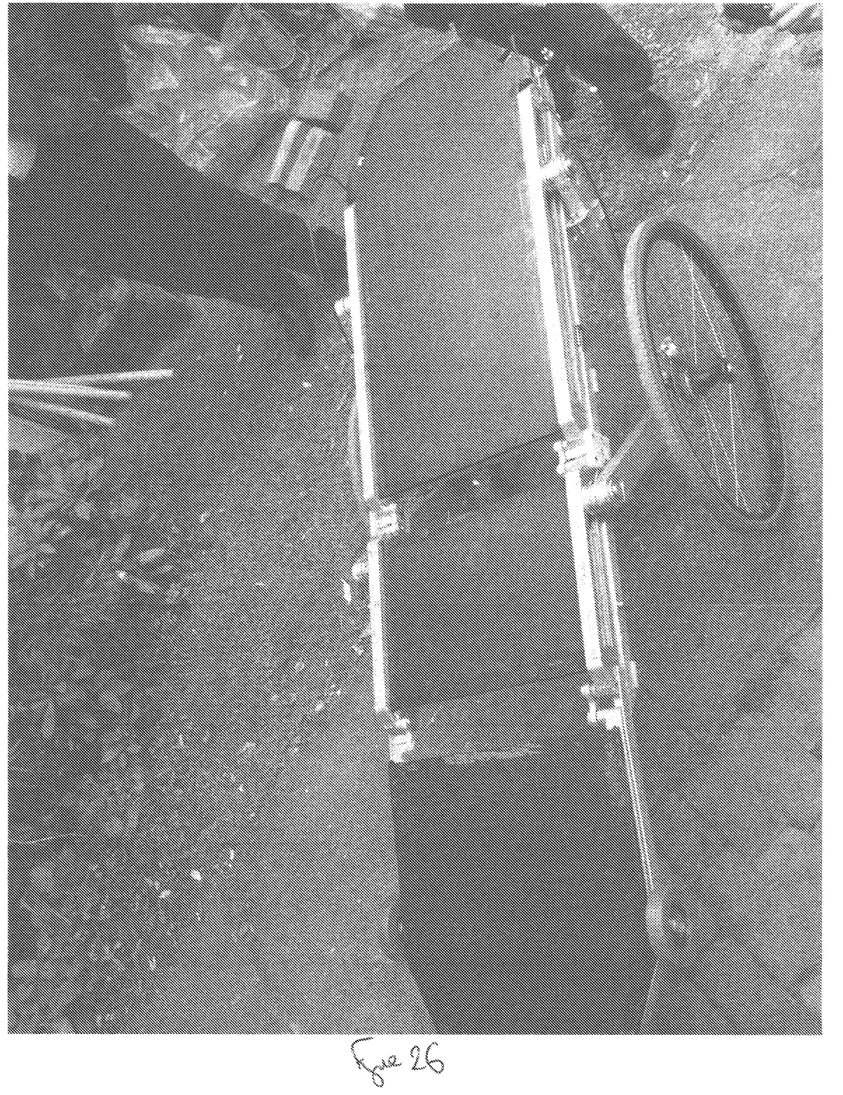

The embodiment shown in FIGS. 16 to 26 has a support 110 having a support 113 which comprises a support frame 120 and a liner or panels associated with the frame and supported thereon. The support frame 113 includes back or torso support sub frame 125 and leg support sub frame 130. The back support sub frame 125 and the leg support sub frame 130 are operatively connected so as to move between a stretcher bed formation or flat support position (FIGS. 23, 24, 25) and a seated or upright support position (FIGS. 19, 20, 21). Peripheral frame elements of the back support sub frame 125 and the leg support sub frame 130 are articulated so as to form trusses with one another in the seated position for increased rigidity, and lie against one another in the flat support position to reduce height. At the vertex of each truss there is provided a hinge for facilitating movement of the support between the stretcher (flat support position) and the seat. The trusses are formed adjacent one another, with one vertex of one truss being substantially common with one vertex of the other truss. The common vertex slides on a common rail to facilitate collapse and deployment. The common rail is one truss arm, being the sub frame base arm.

In order to facilitate movement between the flat and seated positions the support frame 120 includes pivoting elements and sliding elements as shown and described above.

A wheel support frame 170 is provided to support the wheels. The wheel support frame includes wheel support frame arms which move the wheels from a standby position in which a ground engaging portion of the wheel is adjacent the board and a deployed position where the board is elevated from the ground.

The wheel 114 is detachably connected to the wheel support frame with a spring loaded push pin 180 which releases a ball from a detent when pressed. The wheel support frames 170 are connected to the support frame groove 175 in the same way for ease of assembly and disassembly.

The wheel support arms 176, 177 in the embodiment shown in FIGS. 16 to 26 are slidably mounted at their second ends in grooves 175 in the frame to facilitate movement from the standby to the deployed position and to facilitate adjustment into selected intermediate positions between the deployed and standby positions. There are provided two wheel support frame arms pivotally connected to one another at their first ends to facilitate adjustment between deployed and standby positions. The link arms are also pivotally connected to the frame 120 to facilitate sliding movement between deployed and standby positions.

The wheel support frame is detachably mounted on the frame 120 to facilitate disassembly of the transport mechanism into a stowed position. The wheel support frame, for each wheel, is mounted in grooves on peripheral frame elements of a support frame, to facilitate lifting and selection of any suitable height of lift, particularly from ground level. In one embodiment the wheel support frame includes a plurality of wheel support arms pivotally connected by a pivot at a pivoting joint so as to facilitate lifting. In this embodiment there are provided two wheel support arms pivotally connected at a wheel hub at a first end, and pivotally connected to peripheral frame elements at their second ends.

A drive 197 is provided to move the wheels and wheel support frame between the deployed and standby positions. The drive can be actuated from the operator end by a power drill or other rotating drive. The drive includes a drive shaft 199 for transfer of drive power from a position remote the wheel frame 170. The drive shaft 199 is flexible in the embodiment shown to facilitate its attachment to the support frame at selected points along the frame. The drive shaft is in the form of a flexible drive member such as that found in a line trimmer.

The drive also includes a drive element 198 provided at the pivoting joint 179 between the wheel support arms at their first ends so that the joint may be driven to change the angle between the wheel support arms to change the height of the support. The drive element 198 is a gear train so as to provide a mechanical advantage when driving the joint. There is provided a worm gear (not shown) in the joint and one or more bevel gears 196 operatively connected to the worm gear. The drive shaft 199 is provided to drive the one or more bevel gears. There is provided one drive shaft 199 for each bevel gear 196 or a link between the two sides of the support to drive two wheel support frames at once from one drive input position. The drive shaft 199 or each drive shaft may be flexible or jointed with universal joints so as to extend along a contour of peripheral frame elements.

A lock 189 is provided to lock the wheel support frames in the grooves at the side of the support frame.

In one embodiment the pivoting joint 179 has more than 180 degrees of rotation so that the wheel support frame can invert such that the support arms can form a V or an A shape. The wheel support arms 176, 177 are detachably mounted at their second ends to the support frame and thus when the support arms are in the form of a V the wheel is engaging the ground, and the support frame is elevated. When the wheel support arms are in an A-shape, the wheel is held high off the ground at the vertex of the A (joint 179) and therefore it can be seen that the support frame is disposed in a ground engaging position, or close thereto, and the patient can be loaded.

A gearbox 195 for the drive may be provided as shown for increasing the mechanical advantage of an actuator. A worm gear (not shown) may form part of the gearbox. A bevel gear 196 also forms part of the gearbox.

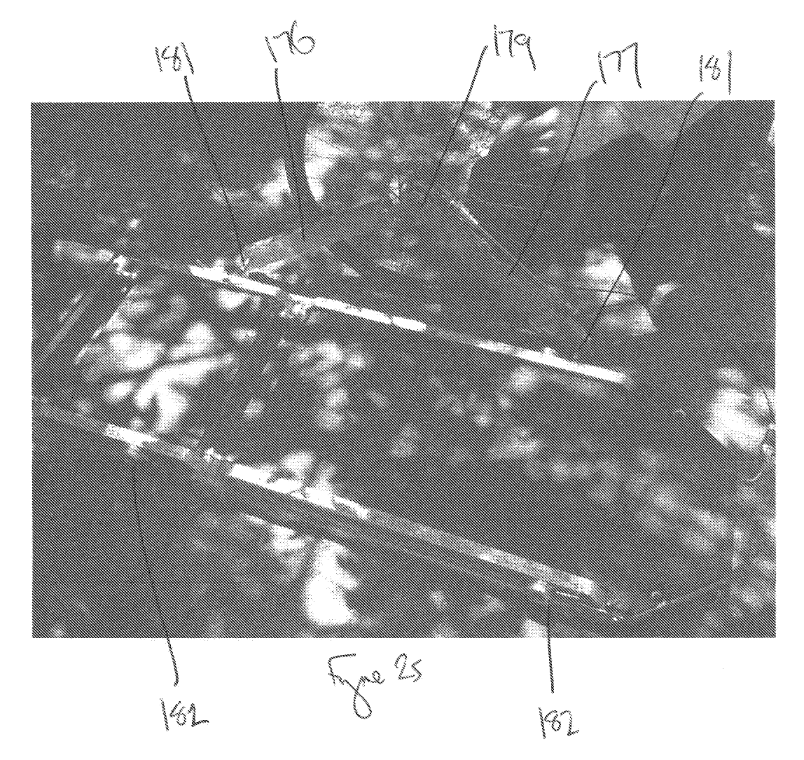

To lift the support frame from a flat position on the ground to an elevated position, the wheel support arms are connected at their ends to the patient support frame as shown (the arms in the upside-down V shape which is an A shape, in FIG. 25). Then, the detachable wheel axle 181 is attached to the bore 182 in the side of the peripheral support frame element. The drive 197 is actuated, whether at the handle end or otherwise, by connecting a power drill, or gas canister, or like device, to the drive shaft 199 and the drive train is rotated, the bevel gear drives the worm gear until the wheel support arms are in a flat position, or extended further until they are in a V-position for greater height of lift.

Then the lockable hinges on the support sub frames may be actuated to form the support into two trusses, and the support may then be folded into the chair position, so that the patient may be moved through tight corners and the like. The two trusses are formed for stability and strength for carrying the patient. A similar drive between two peripheral frame elements may change the angle between two of those elements in a similar way to the way the wheel support elements are angularly driven.

To transport the support along the ground, adjacent the ground, in a flat position, secondary wheels are provided at the ends of the support, disposed on the end pivots of the trusses.

To lock the wheel mounting locks in place on the grooves on the patient support frames, a quick release lock is deployed. Wave washers are used so that a small rotation locks and unlocks the lock.

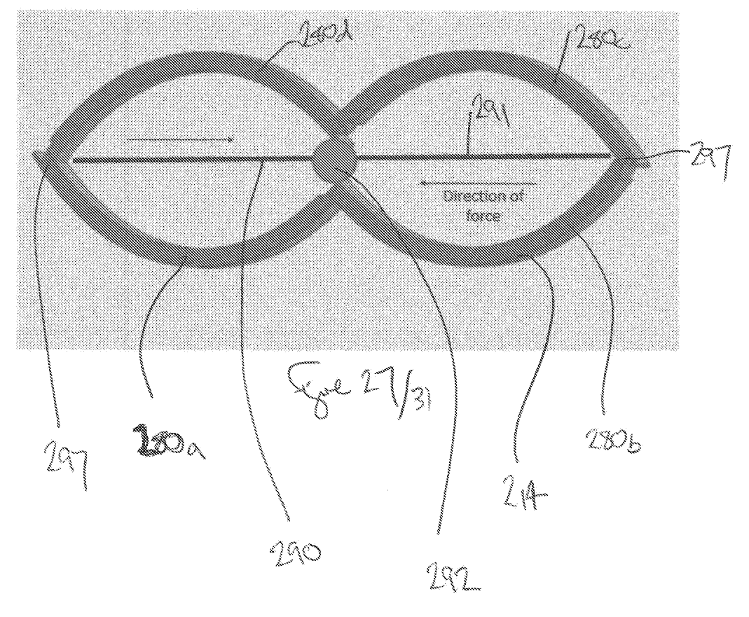

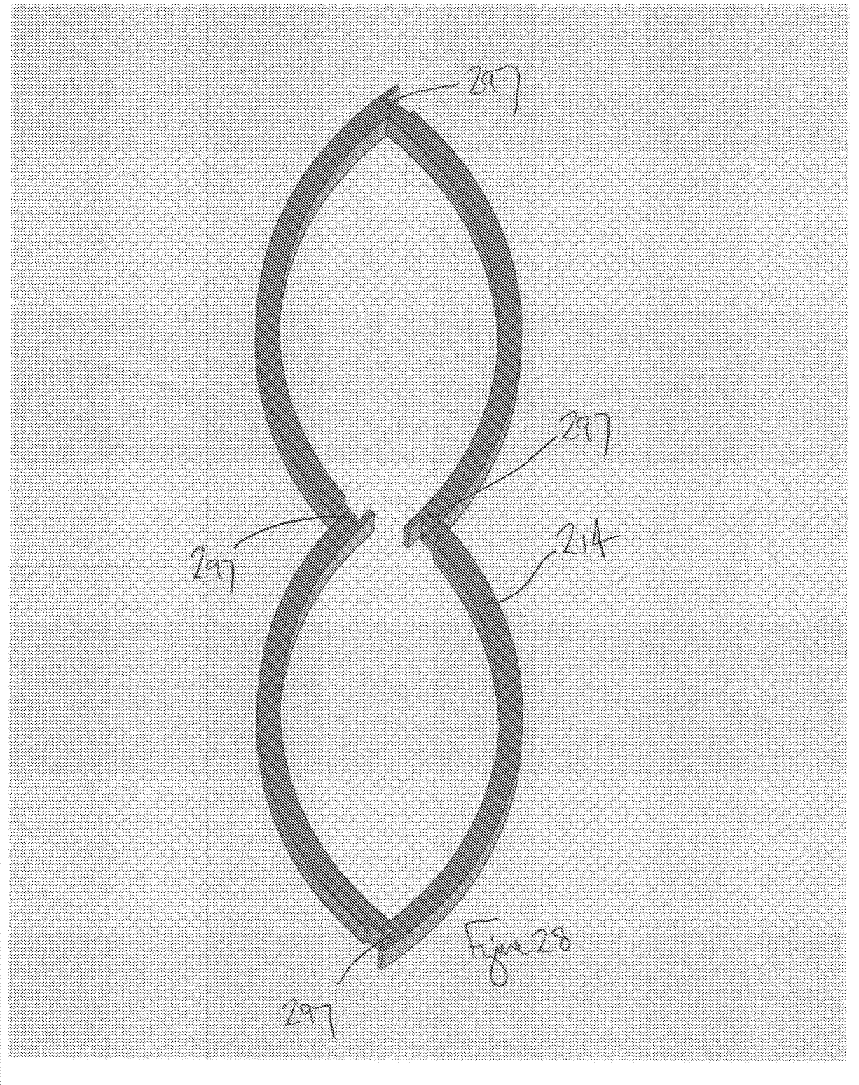

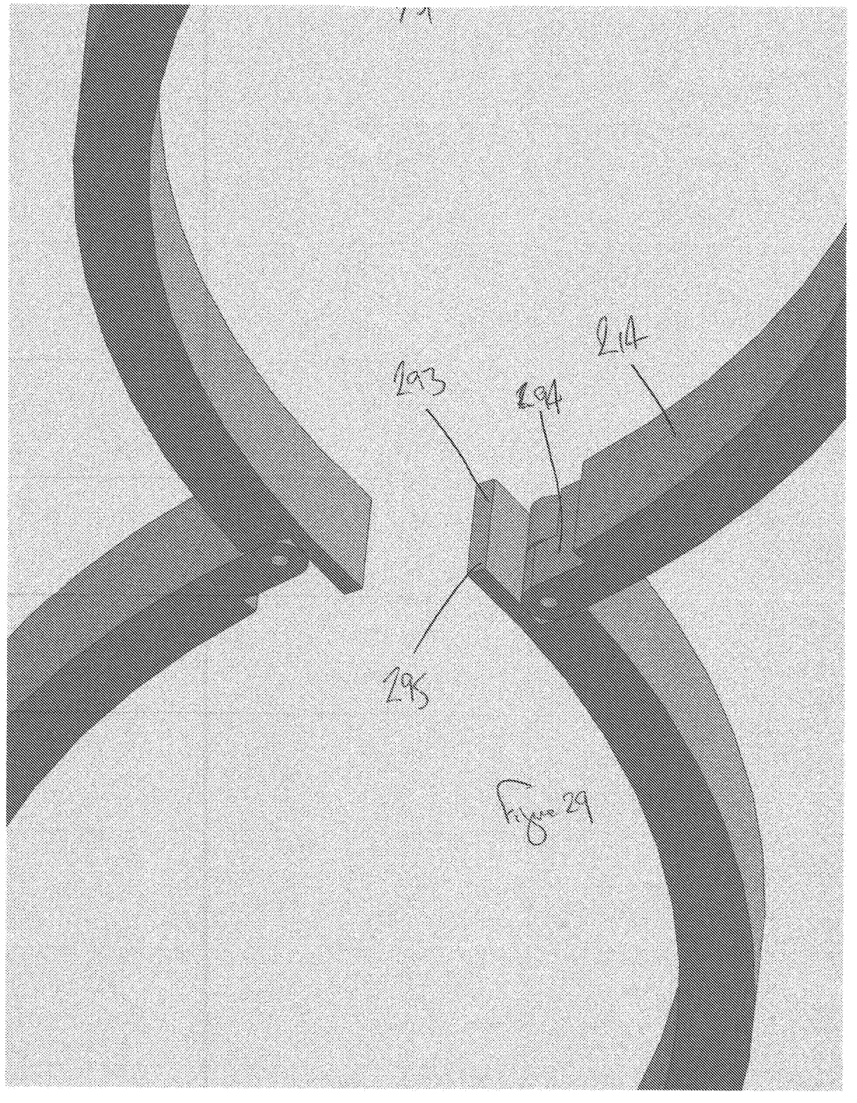

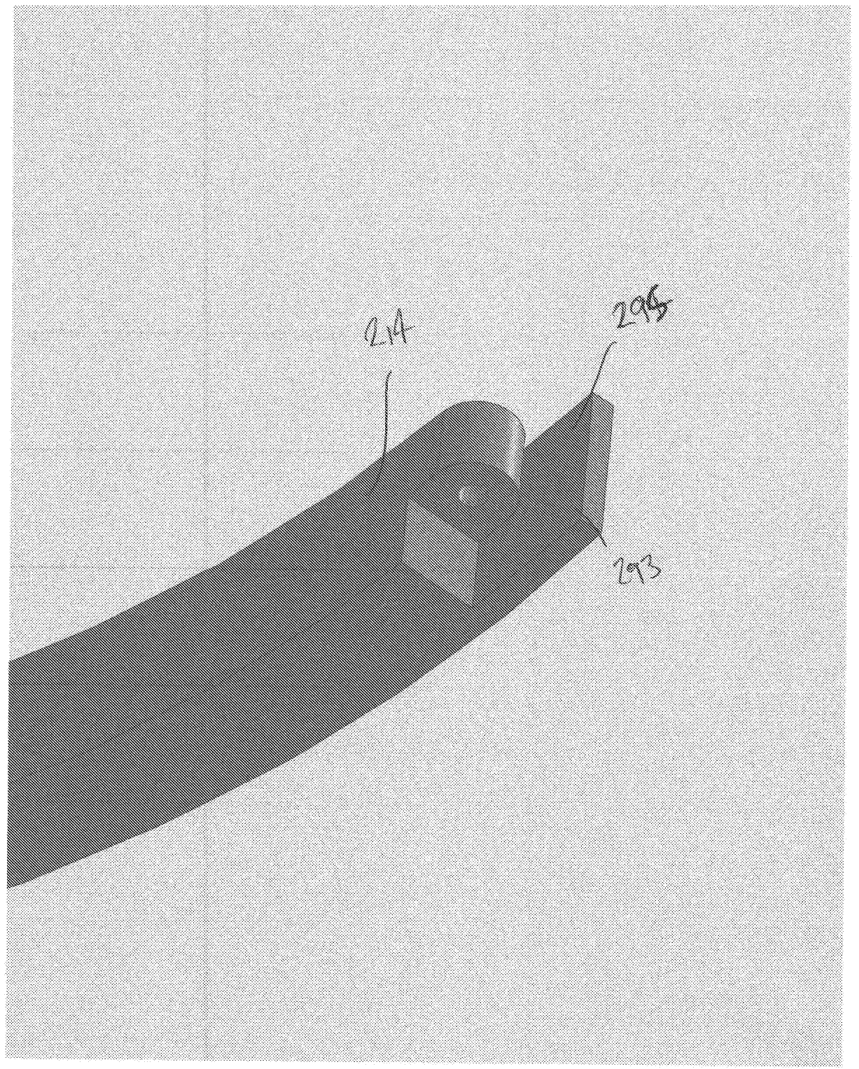

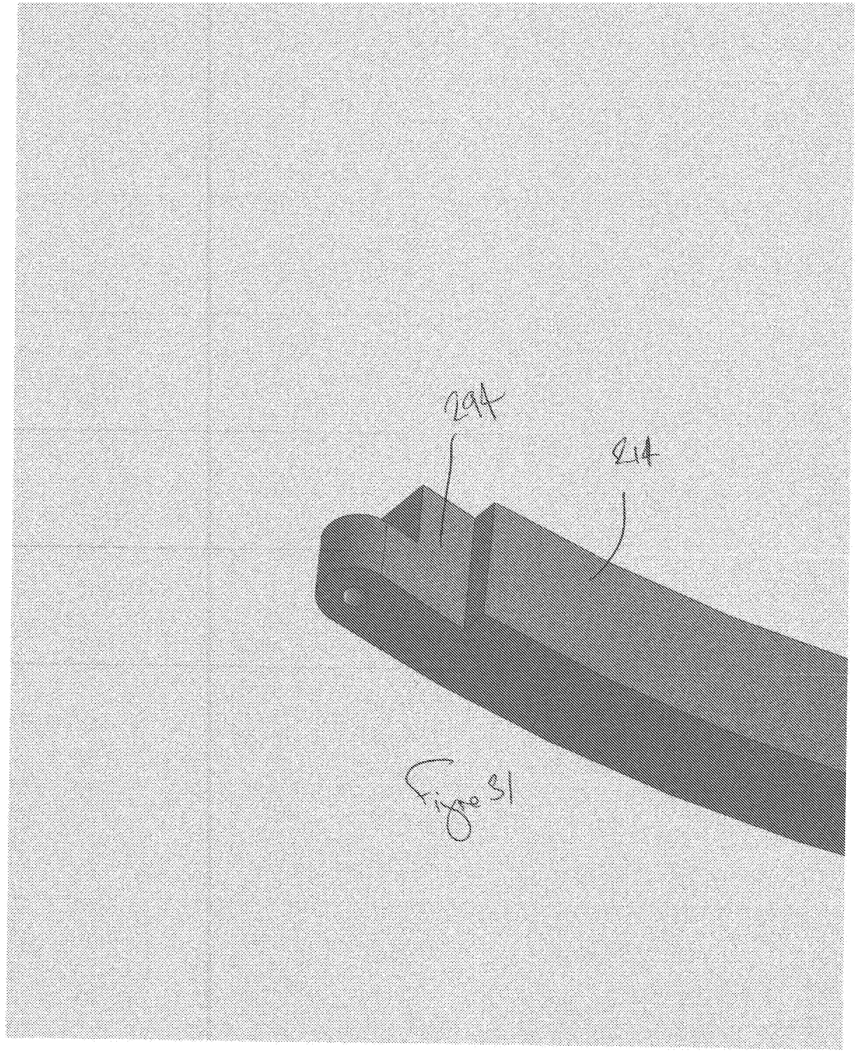

Another embodiment of collapsible wheel is shown in FIGS. 27 to 31. The collapsible wheel 214 shown includes an annulus having a plurality of arcuate elements 280a, 280b, 280c, 280d, connected to one another. In this particular embodiment are shown four arcuate elements. The four arcuate elements are pivotally connected to one another at joints 297 provided at their ends. The arcuate elements are rigid, with some flexibility, such as that found in steel, a plastic, or carbon fibre, or aluminium, or like material. In one embodiment the wheel is about 700 mm in diameter but could be bigger or smaller, to facilitate traversing stairs and other bumps and general contoured terrain.

An adjustable spoke 290 is provided between opposed joints to control the relative disposition of opposed joints or those that are remote from one another. A plurality of adjustable spokes may be provided but in the embodiment shown, only one is used. Each one of the adjustable spokes is a flexible element. In the embodiment shown, each flexible spoke is a cable 291. There is provided a winder or windlass or drawing device 292 to shorten the adjustable spoke to move it from a stowed (or flattened) position to a deployed (rolling) position. The winder may be releasable or on a ratchet so as to allow rapid stowing from a deployed position under the force of gravity.

Each joint of each arcuate wheel element includes a stop 295 to inhibit over-winding or over-deployment into an off-round position and to inhibit wheel collapse in motion. The stop in one form is a lap joint, which includes a tongue 293 at one end of an arcuate element and a tongue receiver 294 at a cooperating position on an adjacent arcuate element. The tongue is on an outside of outer (or end) opposed joints where the cable is attached, so as to inhibit collapse along the cable, and the tongue on an inside of inner (or side) opposed joints is to inhibit collapse when the normal force is on that portion of the wheel, to support a round form when deployed and so as not to inhibit stowing flat.

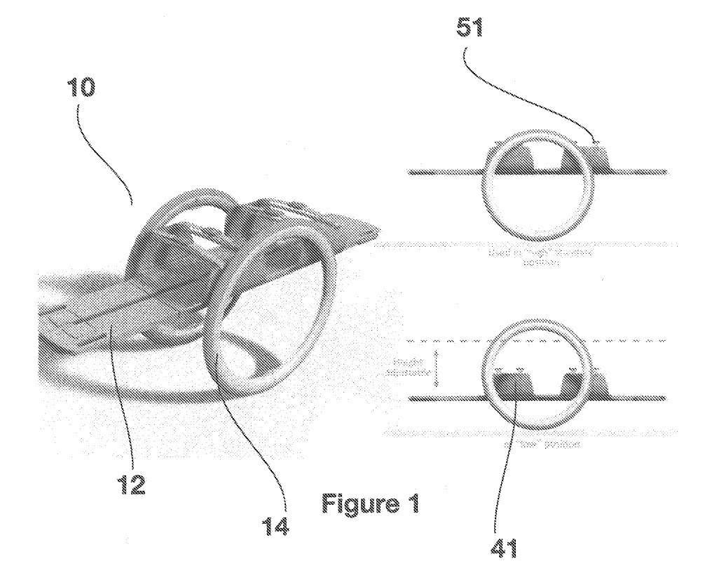

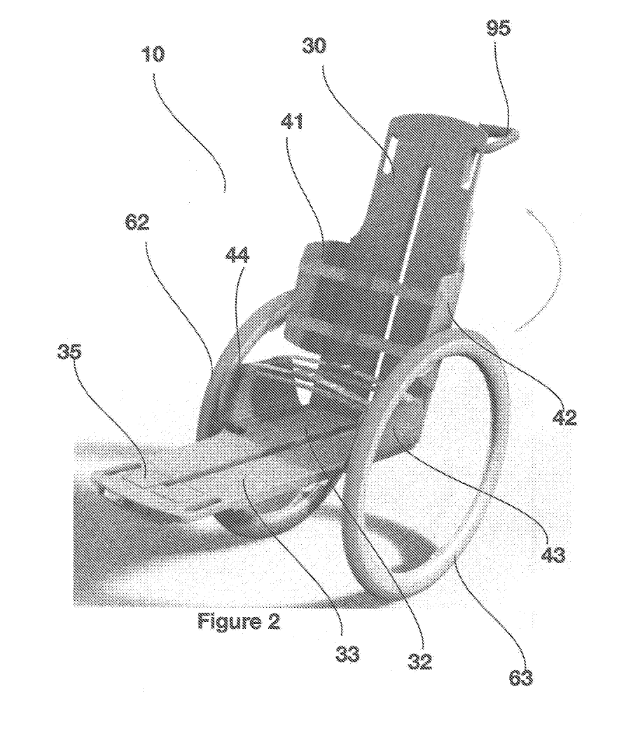

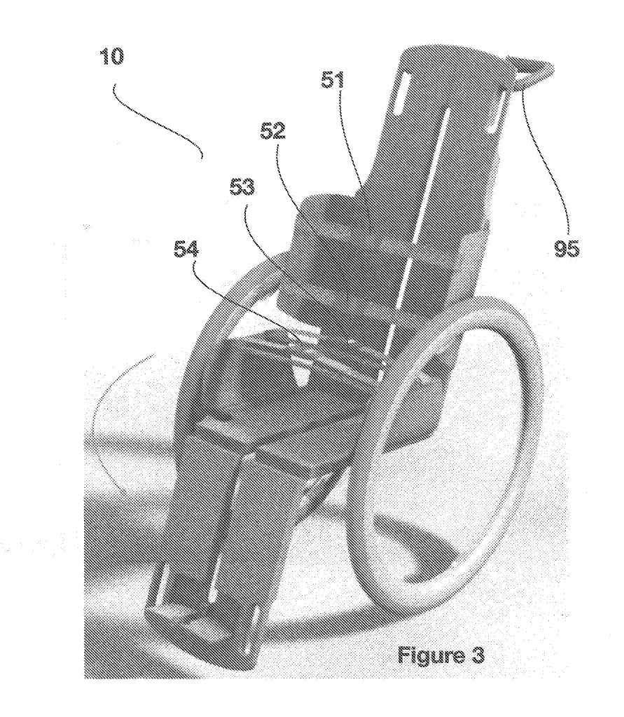

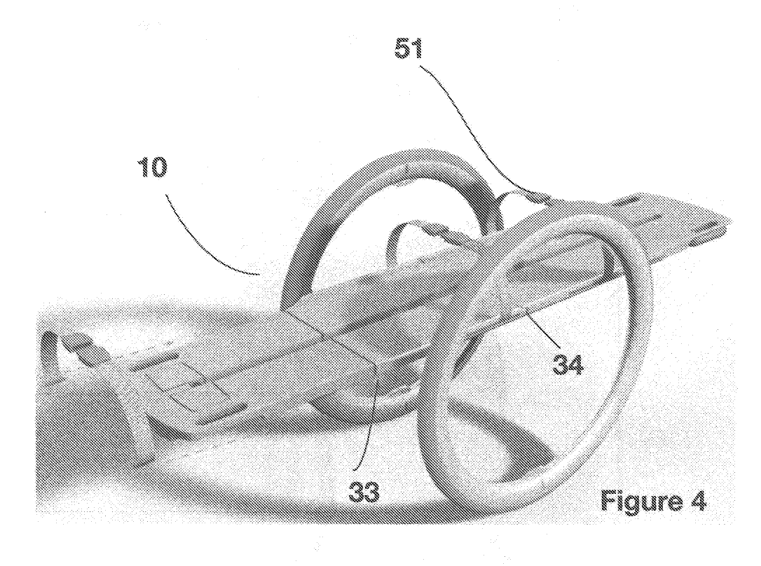

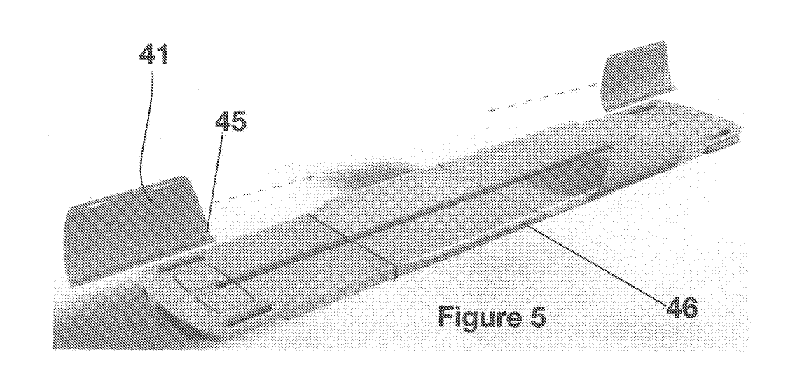

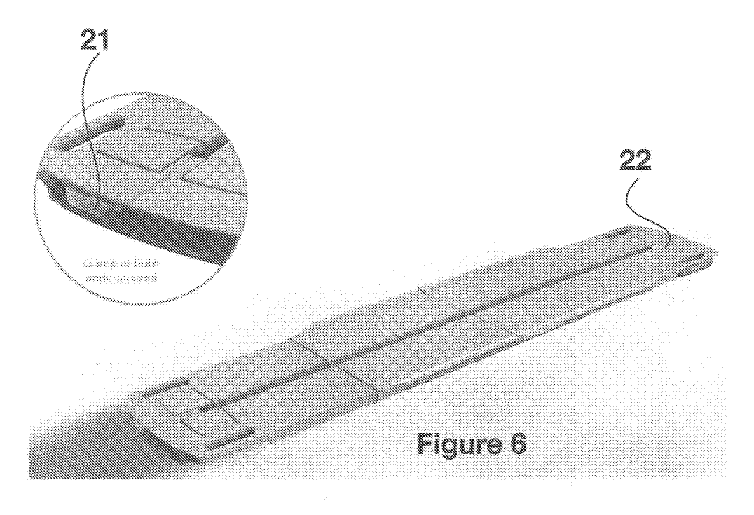

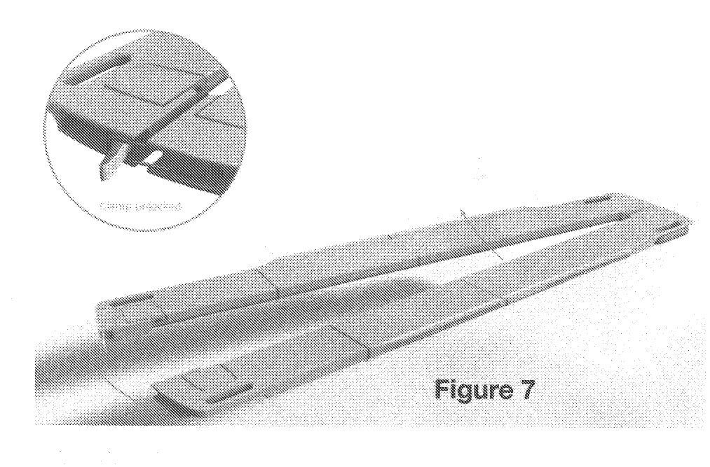

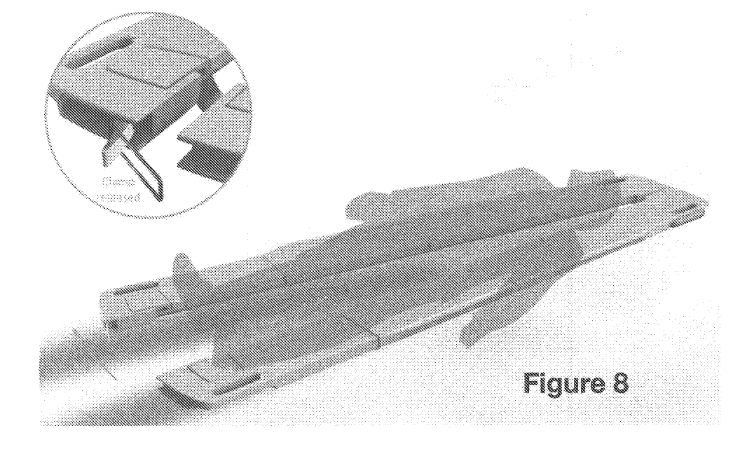

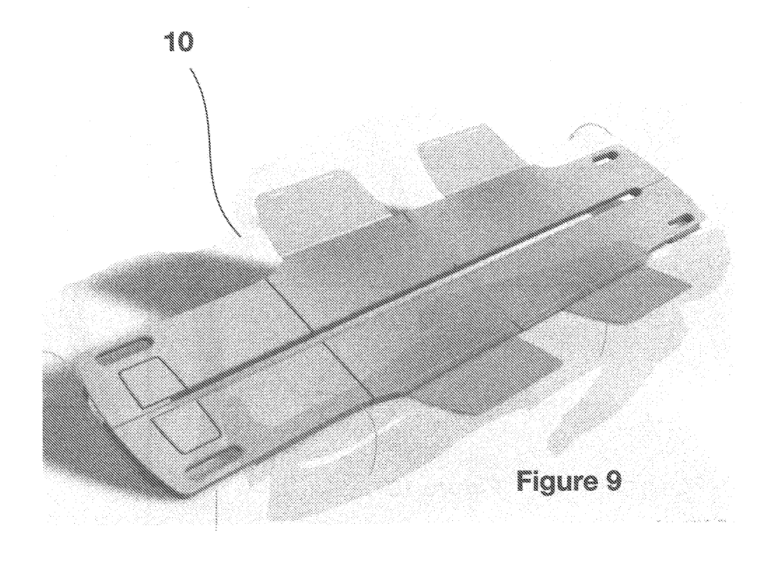

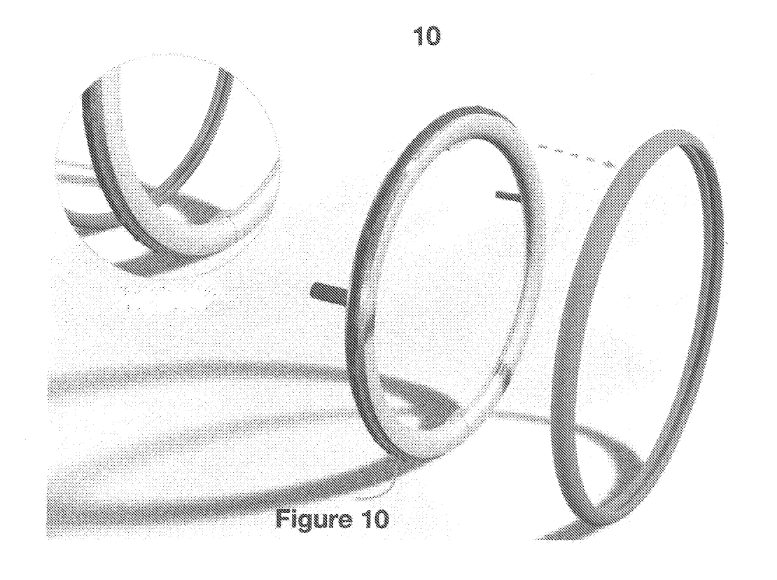

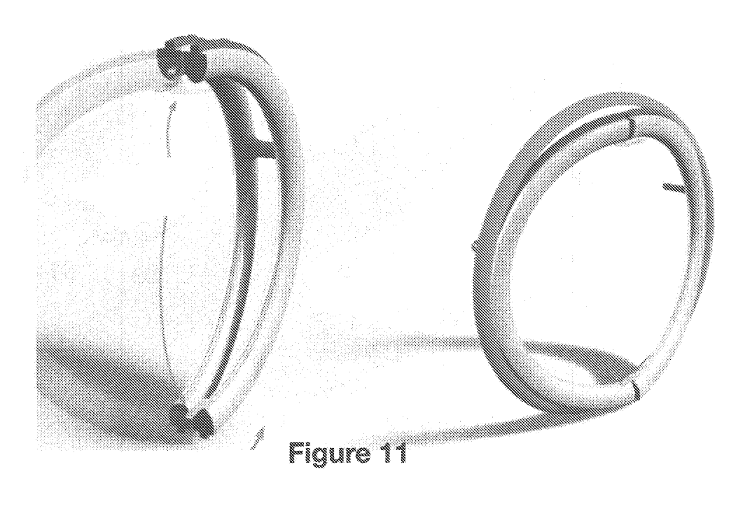

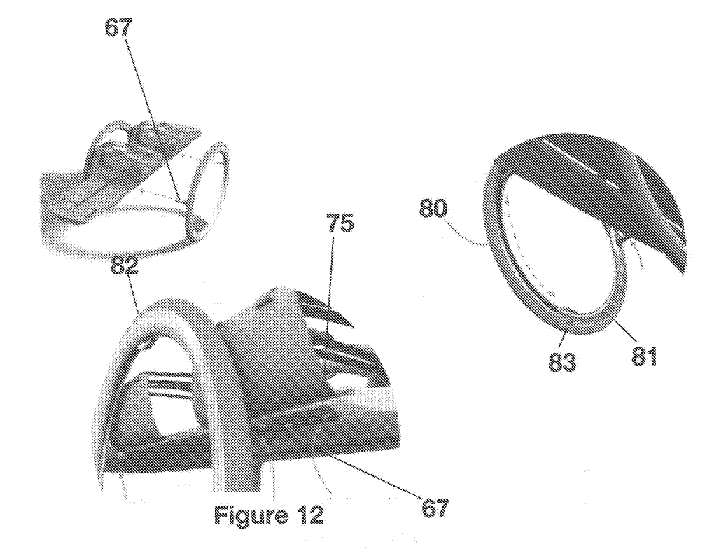

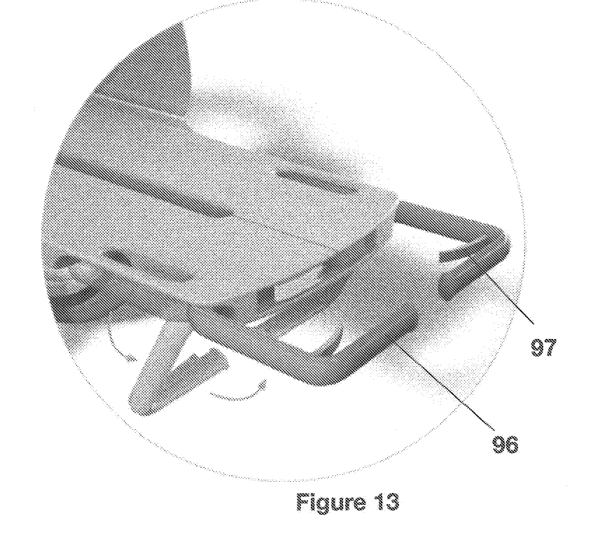

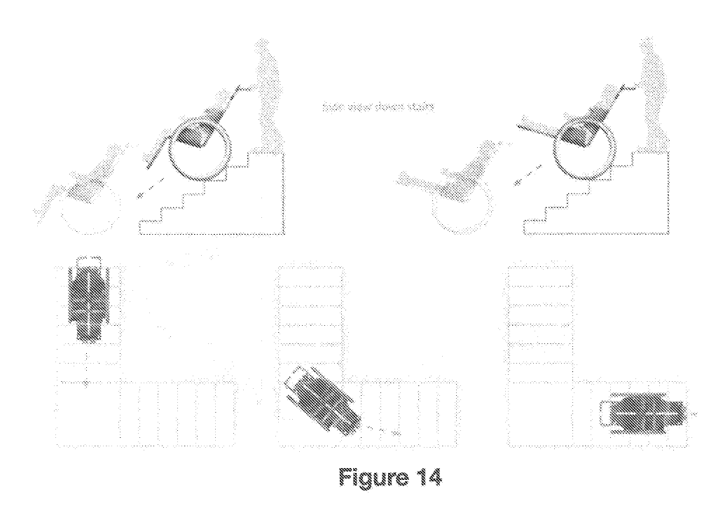

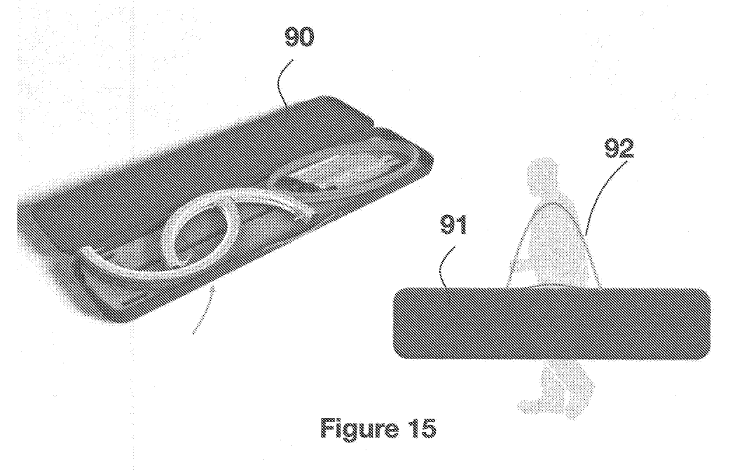

The wheel shown in FIGS. 27 to 31 would connect to the support 120 or 20 in the same way as described in FIGS. 1 to 15 or by the winder 292 fitting on the hub of the wheel support assembly 270.

Turning back to the support, the lift may be in any suitable form for facilitating elevating the support from a ground position to a transport position. The power the lift, an electric motor may be used, powered by a battery on board, or compressed air, again connectable to the support or stored on board, or by hydraulics, stored on board or connectable to the transport. In the embodiment shown the lift is mechanical and driven by the shaft of an externally-powered motor such as a cordless drill. The drive shaft connects with the cordless drill and the lift commences elevating the support from the ground to the elevated position to facilitate transport and loading into an ambulance.

The lift may be operatively connected to the collapsible wheel and when the wheel is connected to the support, the lift draws the cable ends together and the support is then elevated from a ground position to an ambulance-loading position.

Handles 195 may be detachably mounted on a top of the support frame or underneath, so as to obtain the most convenient grip for taking the transport down stairs or up stairs. This is facilitated by through holes 196 in peripheral frame elements or through holes in the board, at a head end of the support frame.

Handles provide grip and braking actuation as shown.

It is to be understood that various embodiments like those above described, and falling within the spirit, scope and ambit of the above described embodiments are intended to be covered by the present specification.

It is also to be understood that the word “comprise” and like grammatical variants including “comprising” are to be taken as inclusive and not excluding other components or features.

1. A transport for material, item or a subject, the transport including:
a. a support for the material, item or subject;
b. one or more detachable ground engaging wheels, detachable from the support at a detachable mount;
c. one or more lifts to facilitate lifting the support from ground level to a selected height, the lift being operatively connected to the support and the one or more detachable ground engaging wheels, when the wheels are attached to the support.

2. The transport in accordance with claim 1 wherein the support includes a support frame for providing a structure to the support, the support frame including articulated sub frames for supporting various parts of a subject.

3. (canceled)

4. (canceled)

5. The transport in accordance with claim 2 to wherein the articulated sub frame assemblies include peripheral frame elements for mounting the ground engaging wheels and board elements mounted between or on the peripheral frame elements.

6. (canceled)

7. The transport in accordance with claim 2 wherein the support frame is configured to articulate between an elongate or stretcher position to a collapsed or chair position to facilitate negotiating tight turns in small spaces.

8. The transport in accordance with claim 2 wherein the there are provided secondary ground-engaging wheels mounted on the sub-frame to facilitate sliding the support frame under a fallen subject.

9. The transport in accordance with claim 1 wherein each ground engaging wheel is a collapsible wheel.

10. The transport in accordance with claim 9 wherein the collapsible wheel includes a hub that is in the form of an annulus.

11. The transport in accordance with claim 10 wherein the annulus is detachably mounted to the board, for detachably holding the annulus fixed against a side portion of the support.

12. The transport in accordance with claim 9 wherein the collapsible wheel includes an annulus having a plurality of arcuate elements pivotally connected to one another at articulated joints.

13. The transport in accordance with claim 12 wherein there are provided two, three, four, five, six, seven, eight, nine, ten, eleven, or twelve arcuate elements.

14. (canceled)

15. The transport in accordance with claim 12 wherein one or more adjustable spokes are provided between opposed arcuate elements to control the relative disposition of opposed arcuate elements.

16. The transport in accordance with claim 15 wherein each one of the adjustable spokes is a cable and there is provided a winder to shorten each adjustable spoke to move if from a stowed position to a deployed position.

17. (canceled)

18. The transport in accordance with claim 12 wherein each articulated joint includes a stop to inhibit over-winding or over-deployment into an off-round position, the stop being a lap joint, which includes a tongue at one end of an arcuate element and a tongue receiver at a cooperating position on an adjacent arcuate element.

19. (canceled)

20. (canceled)

21. The transport in accordance with claim 21 further including a wheel support frame for each wheel, each wheel support frame being adapted to detachably mount to the support, within grooves on peripheral frame elements of the support frame and wherein the wheel support frame includes a plurality of wheel support arms pivotally connected by a pivot at a pivoting joint so as to facilitate lifting.

22. (canceled)

23. The transport in accordance with claim 21 wherein the pivoting joint has more than 180 degrees of rotation so that the wheel support frame can invert such that the support arms can form a V shape or an A shape.

24. The transport in accordance with claim 21 wherein a drive is provided at the pivoting joint so that the pivoting joint may be driven to change the angle between the wheel support arms to change the height of the support.

25. (canceled)

26. (canceled)

27. (canceled)

28. (canceled)

29. (canceled)

30. (canceled)

31. (canceled)

32. A transport for material, item or a subject, the transport including:
a. a support for the material, item or subject;
b. one or more ground engaging wheels;
c. one or more lifts to facilitate lifting the support from ground level to a selected height, the lift being operatively connected to the one or more ground engaging wheels, wherein each ground engaging wheel is collapsible and includes:
i. a plurality of articulated arcuate segments;
ii. one or more adjustable spokes connected to a respective segment at opposed ends thereof so that adjustment of the spoke deploys or stows the collapsible wheel;
iii. a spoke adjuster connected to the lift to adjust the one or more spokes.

33. The transport in accordance with claim 32 wherein the spoke is a flexible element and the spoke adjuster is a winder configured to adjust the length of the one or more spokes.

34. (canceled)

35. (canceled)

36. (canceled)

37. The transport in accordance with claim 32 wherein each articulated segment includes a stop to inhibit over-winding or over-deployment into an off-round position, the stop being a lap joint, which includes a tongue at one end of an arcuate element and a tongue receiver at a cooperating position on an adjacent arcuate element.

38. A collapsible ground engaging wheel for facilitating transport of a subject, the collapsible ground engaging wheel including:
a. a plurality of articulated arcuate segments;
b. an adjustable spoke connected to opposed or remote ends so that adjustment of the spoke deploys or stows the collapsible wheel;
c. a spoke adjuster
d. wherein each articulated arcuate segment includes a stop to inhibit over-winding or over-deployment into an off-round position, the stop being a lap joint, which includes a tongue at one end of an arcuate element and a tongue receiver at a cooperating position on an adjacent arcuate element.
